(19) United States
(12) Patent Application Publication
(10) Pub. No.: US 2006/0097430 A1
(43) Pub. Date: May 11, 2006

(54) UV pulsed laser machining apparatus and method

(76) Inventors: Li Xiaochun, Madison, WI (US); Choi Hongseok, Madison, WI (US); Jeffrey S. Platkowski, Richmond, TX (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/982,433

(22) Filed: Nov. 5, 2004

(51) Int. Cl. B23K 26/38

(52) U.S. Cl. 264/400; 219/121.72

(57) ABSTRACT

A method of cutting polycarbonate thin sheets generally less than 2 millimeters includes providing a source of pulse ultraviolet (UV) radiation. In operation, the method includes directing the UV radiation at the polycarbonate sheet to photo-ablate the polycarbonate sheet. A combination of parameters associated with the radiation may be selected, including at least one of a group of fluence, speed, coating of polycarbonate, number of passes, increasing or decreasing focal length, changing focus position and focus spot size.

### BACKGROUND OF THE INVENTION

1. Field of the Invention

The present invention is directed to a tool and process for machining and/or cutting polycarbonate substrates, and more particularly, a tool employing an ultraviolet (UV) pulsed laser that processes based on photo-ablation. More specifically, a parameter window has been established allowing the skilled practitioner the ability to precisely and repeatably photo-ablate thin polycarbonate.

2. Description of Related Art

In the United States alone, specialty printing is a 12.6 billion dollar industry. The manufacture of thin (0.2 to 2.0 mm) polycarbonate displays and faceplates make up a substantial portion of that business. Polycarbonate faceplates are used on a variety of consumer products, such as home appliances and automobile interiors, to provide permanent, highly visible exterior features.

Many of the industries utilizing polycarbonate faceplates are highly competitive. Oftentimes only subtle differences exist between the products of competing manufacturers. As a result, the overall aesthetic appearance of the product is often a critical factor in point of sale presentation of the product. Thus, the manufacturers of such products demand an extremely high level of quality for the accentuating faceplate. Cheaper, less robust material may not be readily substituted for the polycarbonate faceplate and only those polycarbonate faceplates manufactured to highest quality have met the industries' high aesthetic standards.

In the past, high volume production of polycarbonate faceplates has typically employed mechanical cutting using a punch and die to cut out the displays. The various die-cutting processes work well for punching out features with large curvatures, however, the creation of intricate shapes, small internal circles and other intricate features present challenges due to the weak nature of the thin polycarbonate sheet and the limitations of mechanical dies.

Due to the necessity for quality products, and the limitations of the current manufacturing process, the polycarbonate face plate industry is plagued by high tooling costs. The slightest misalignment of the precision tools used in the manufacture of the polycarbonate faceplates can destroy the quality of the die. Furthermore, face plate manufacturers cannot maintain a die for long periods of time, as most industries utilizing faceplates, such as the appliance and automobile manufacturers, give their products face lifts on an annual or even biannual basis.

The most common die systems for high volume manufacture of polycarbonate faceplates include a sheet or roll fed system incorporating steel rule dies. As noted above, the process works well for cutting out the perimeter of faceplates of sheets of up to 0.030 inches. Top and bottom base plates hold the sheet or roll firmly into position. After the internal holes are cut, the perimeter of the faceplate is cut out. The perimeter is often cut in a traditional punch and die fashion wherein a die driven from overhead cuts out the shape.

One commonly viewed problem of die systems is that cutting thicker sheets with steel roll dies can cause rolling and burring. This is also a problem for thinner sheets when the steel rule die is duller, the sheet is not held taut, or there is a misalignment of the top and bottom dies. The solution to rolling and burring is to incorporate higher precision dies with smaller clearances. The higher precision dies, however, are expensive to produce, and the slightest misalignment of the die causes the tools to crash, completely destroying the die.

The greatest problem with dies is exhibited in cutting small circles (less than ¼″ diameter) and internal curved features with very small widths. While employing the aforementioned methods, and frequently sharpening the cutting surfaces of the die can improve the ability of the dies to cut the intricate shapes, a considerable amount of scrap is typically generated in the die cutting process. Furthermore, the more irregular features on the steel rule cutting die, the more expensive it is to produce, and the more likely it is to crash through misalignment.

It is also known to use basic woodworking tools to cut thin polycarbonate sheets. For sheet thicknesses down to about 0.015 inches (381 microns), a horizontal overhead panel saw may be used. Blades of 10 or more inches in diameter typically have 60 to 80 carbide-tipped teeth. Despite the availability of these processes, great difficulty has been experienced in using table, or bench circular saws, band and reciprocating saws. Scribbing and breaking commonly occurs with the thin sheets, and the force necessary to propagate the notch is high. While drilling can be done, very slow speeds are required. Furthermore, the area not being drilled must be held taut, usually with a jig, which can mark the polycarbonate in a manner that is unacceptable.

Some face plate manufacturers employ systems using a small (¼″ diameter) rotary tool over an x-y-z-table. These cutters can also cut the polycarbonate. However, the use of a rotary tool to cut polycarbonate sheets has been shown to offer limited precision, even when they employ advanced CNC technology.

Flatbed plotter cutters offer the graphic arts industry the greatest flexibility and accuracy for low volume and prototype jobs. With cutting speeds of up to 50 cm/second, these plotters offer more consistent accurate performance than the previously mentioned methods. They can cut to tight tolerances, including tight circles. However, the tool must be changed for different types of cuts. The system achieves accuracy, but relinquishes robustness, as these systems are intended for making prototypes, and not to be implemented on the shop floor.

Due to the aforementioned problems, attempts have been made to incorporate laser cutting into such industries as the graphic arts industry, where the goal is to cut thin materials at a rapid speed. Priced competitively with mechanical systems, CO₂ lasers are starting to be employed to manufacture some faceplates. CO₂ lasers have the advantage that there are no mechanical tooling costs, and cutting speeds of up to 120 inches per second can be achieved.

Almost all of these known laser cutting systems use a CO₂ laser to perform the laser cutting. Operating at maximum cutting speed of up to 315 inches per second, the Laser Sharp System, a trademark of LAS-X industries, incorporates software allowing the user to index CAD files for processing, or “process-on-the fly.” To achieve such high speeds, the systems incorporate post object scanning wherein the beam moves along the cutting path, as opposed to traditional systems where the x-y-z-table is moved and the beam is stationary. Custom material handling systems are utilized to feed sheets of stock material or rolls of material into the system.

Despite the described advantages of the current laser systems, the LAS-X system and others incorporating a CO₂ laser have shown a tendency to burn the material. Furthermore, by operating at very high speeds, the systems have a tendency to cauterize the edges of the material. Due to these deficiencies, the quality of the samples cut by current laser systems have been unacceptable for a majority of the industry. As long as a CO₂ laser cutting system utilizes a thermal cutting process, there will be detrimental thermal effects from the cutting process. These effects are often exacerbated when the thickness of the material is increased.

The current state of mechanical and laser cutting of polycarbonate thin sheets offers obvious limitations. Mechanical cutting struggles to cut intricate internal circular features and is unsuitable for high production volume runs because the cost of making the cutting die is so expensive. Flatbed plotters provide the flexibility of a CAD/CAM system, but are slow, require tool changes, and are not robust enough for shop floor applications. Laser cutting, currently driven by CO₂ lasers, offers high speed and the flexibility of a CAD/CAM system, but quality suffers with this thermal cutting process.

In view of the above, graphic art industries have an obvious need for a versatile, easily reconfigurable, and inexpensive laser cutting apparatus for cutting thin poly-carbonate sheets. A system is needed that can cut as well or better than a mechanical cutting system, but offers all of the advantages of a laser cutting system without any adverse effects on quality.

It is a goal of the present invention to provide a UV pulsed laser capable of economically cutting thin polycarbonate sheets at a high speed for use in a commercial setting. It is a further goal to provide the details of the various control elements or parameters of a UV pulsed laser, such as fluence (power), cutting speed, focus size, coating of polycarbonate, number of passes, focal length, focus position etc., and their interaction with polycarbonate sheets.

### SUMMARY OF THE INVENTION

The preferred embodiment is directed to a laser-based cutting apparatus and method for processing polycarbonate sheets using photo-ablation. Preferably, an ultraviolet (UV) pulsed laser is employed. By controlling the parameters of the process, including the fluence, cutting speed, focus size, inked or similar coating of polycarbonate, use of a thin protective polyethelene film over the substrate, number of passes, focal length, focus position, focus spot size of the laser, while mounting the substrate taut across a jig with no material beneath the substrate (air only) high cutting quality can be maximized. Furthermore, parameters have been established that would allow the practitioner the ability to use the techniques described in this application with other commercially available lasers, and merely modify cutting parameters based on known equations and identified parameters.

More specifically, a parameter window has been established allowing the skilled practitioner the ability to cut thin polycarbonate sheets with minimal thermal damage, while minimizing the amount of energy required to perform the cut or scribe. Also, the parameters developed can be used to extrapolate the depths and speeds that would be obtained if a UV pulsed laser operating at a higher frequency were used. And, the techniques and parameters described herein allow the user to scribe, engrave, or otherwise mark the polycarbonate thin sheets in a predictable, repeatable manner. Overall, the preferred embodiments are directed to a pioneering commercial use of an Nd:YAG pulsed laser for cutting and scribing thin polycarbonate sheets.

According to one preferred embodiment, a method of cutting polycarbonate includes providing a source of pulsed ultraviolet (UV) radiation. In addition, the method includes directing the UV radiation at the polycarbonate to photo-ablate the polycarbonate sheet.

According to another aspect of this embodiment, the method includes selecting a combination of parameters associated with the radiation. In this case, the parameters may include at least one of a group including overlap (speed of cutting/marking/etc.), size of an iris, coating the polycarbonate with ink, utilizing a film over the top of the substrate, number of passes, mounting taut on a jig with no backside interface, and changing focus position.

In another aspect of this embodiment, the method further includes modifying the overlap so as to increase cutting efficiency. For example, the overlap rate could be increased to 25% between pulses.

According to a further aspect of this embodiment, the parameters are adjusted to focus the beam on the bottom of the polycarbonate substrate. In addition, a z-table is raised 20 microns after each pass. In another aspect of this embodiment the laser makes multiple passes over the polycarbonate.

According to a further aspect of this embodiment, the UV radiation has a wavelength in a range equal to about 150 nm to 280 nm. More preferably, the UV radiation has a wavelength equal to about 266 nm. In another aspect of this embodiment, an iris of the laser has a diameter of about 3.5 mm.

In another preferred embodiment, an apparatus for cutting a polycarbonate sheet includes a laser that emits radiation having a wavelength in the ultraviolet range. In addition, the combination of parameters associated with the radiation is selected so that the laser photo-ablates the polycarbonate sheet.

In another aspect of this embodiment, the parameters include at least one of a group including speed, coating the polycarbonate, increasing the number of passes, increasing or decreasing the focal length, changing the focus position, and focus spot size. In addition, the UV radiation has a wavelength in a range equal to about 150 nm to 280 nm. More preferably, the UV radiation has a wavelength equal to about 266 nm.

According to another preferred embodiment, a method of processing the polycarbonate includes mounting the substrate on a jig in such a manner that the substrate is mounted taut, with no backside interface, i.e., there is an air gap between the bottom of the substrate and the jig. This free space helps prevent unwanted and often problemsome markings on the reverse side of the thin polycarbonate sheets.

According to another preferred embodiment, a method of processing the polycarbonate includes providing a laser that generates ultraviolet (UV) radiation, and selecting operation parameters associated with the laser, wherein the parameters include speed, coating the polycarbonate, number of passes, increasing or decreasing focal length, changing focus position and spot size. In addition, the method includes directing the UV radiation towards the polycarbonate so as to photo-ablate the polycarbonate.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a schematic view of an ultraviolet laser used to cut polycarbonate according to the preferred embodiment;

FIG. 2 is a schematic view of polycarbonate processed by the UV laser of FIG. 1, illustrating the product before and after photo-ablation;

FIG. 3 is a schematic view of the prisms utilized in the optical system of the laser of FIG. 1;

FIG. 4 is a schematic view illustrating the relationship of overlap and speed;

FIG. 5 is a graph showing cutting depth versus percent overlap of the laser of the preferred embodiment, shown for a polycarbonate substrate;

FIG. 6 is a graph showing cutting depth as a function of varying fluence at different speeds of the preferred embodiment, shown for polycarbonate;

FIG. 7 is a graph showing cutting depth as a function of fluence at different speeds of the preferred embodiment, shown for polycarbonate;

FIG. 8 is a graph showing cutting depth as a function of fluence at different speeds performed on coated material of the preferred embodiment, shown for polycarbonate;

FIG. 9 is a graph showing cutting depth as a function of fluence on differently coated samples when the speed is held constant at 50% overlap of the preferred embodiment, shown for polycarbonate;

FIG. 10 is a graph showing cutting depth as a function of the number of passes when the focus height remains unchanged of the preferred embodiment, shown for polycarbonate;

FIG. 11 is a graph showing cutting depth as a function of the number of passes when the separation between the optical system and the substrate is increased after each pass;

FIG. 12 is a graph showing cutting depth as a function of the number of passes when the focus spot is positioned so that it is embedded further into the substrate after each pass;

FIG. 13 is a graph showing cutting depth versus the number of passes when the focus is aimed at the top, middle and bottom of the sample;

FIG. 14 is a table showing data for focus position and the number of passes;

FIG. 15 is a flow chart illustrating a process of photo-ablating the polycarbonate according to the preferred embodiment; and

FIG. 16 is a perspective view of a mounting jig for accommodating polycarbonate substrates in the preferred embodiments.

### DETAILED DESCRIPTION OF THE PREFERRED EMBODIMENT

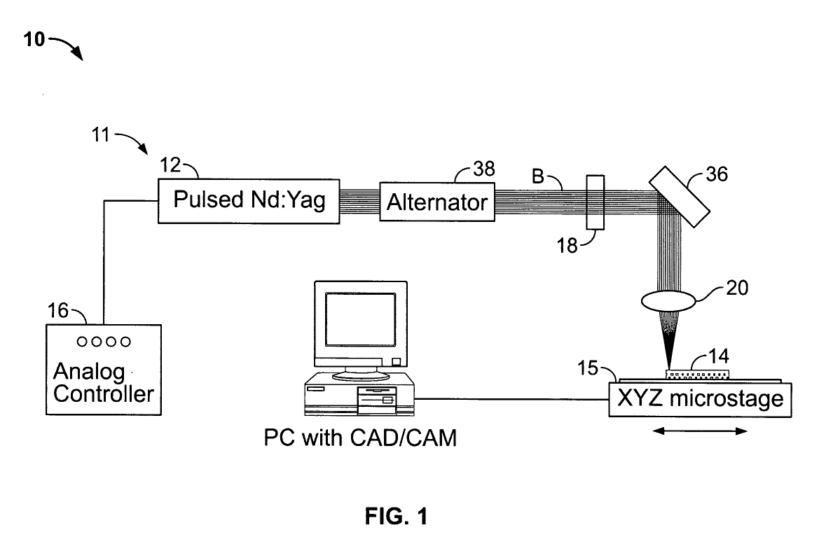

Turning initially to FIG. 1, a laser cutting system 10 according to the preferred embodiment includes an optical system 11 having a laser 12 driven by a power source, the laser producing a beam of electromagnetic energy. In the preferred embodiment, the beam is in the ultraviolet frequency range, and is directed toward a polycarbonate substrate 14 generally orthogonally thereto. For example, the substrates that are the subject of much of the following discussion are thin polycarbonate sheets having a thickness of about 381 microns. That said, the techniques described herein are particularly useful for machining polycarbonate substrates having thicknesses in a range of about 0.1-2 mm.

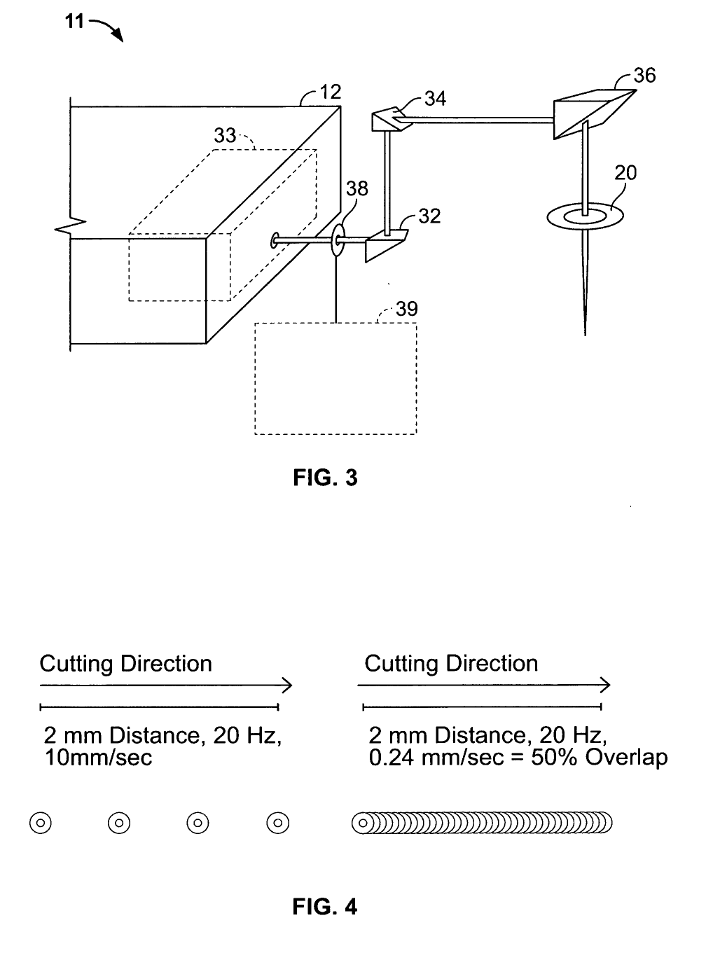

In addition to laser 12, optical system 11 includes an attenuator or iris/aperture 38 (FIG. 3) that is employed to facilitate producing a high quality beam for processing the polycarbonate, described in further detail below. Optical system also includes a reflector or prism 36 and a lens 20, both used in directing and conditioning beam “B” to impinge upon substrate 14 with selected characteristics, described below.

Substrate 14 is preferably mounted on a table or microstage 15, as shown in FIG. 1, while a custom jig (see FIG. 16, described in further detail below) is used to secure the polycarbonate sheet 14 onto the microstage 15. Laser 12 is preferably controlled by an analog control unit 16 that communicates to actuate laser 12 according to the user's desired processing performance characteristics. These processing parameters are application-based including cutting and marking operations on polycarbonate substrates of varying characteristics, discussed in further detail below. It is understood that laser 12 could also utilize an alternate digital-based control system as well. A computer 17 having an imaging software system is also provided. More particularly, computer 17 is operable to generate commands for providing relative scanning, or other three-dimensional positioning, motion between the optical system and the substrate mounted on the stage during a user-defined laser machining operation.

Preferably, an Nd:YAG laser incorporating a neodymium-doped yttrium-aluminum-garnet rod as an excitation medium is utilized. The preferred Nd:YAG laser allows for the generation of a short pulse beam with a duration shorter than 10 ns through the use of the known Q-switch technique. A duration of about 8 ns is preferred. This short pulse is effective in reducing the thermal damage of the laser beam to the polycarbonate sheet 14 which in turn improves the precision and resolution of laser micro-machining. Preferably, the Nd:YAG laser system can generate first, second, third and fourth harmonic modes from the laser beam by the harmonic generators in its laser head. Thus, the preferred pulsed Nd:YAG laser system has different harmonic modes (1064 nm, 532 nm, 355 nm, and 266 nm) for processing polycarbonate substrate 14. Preferably, the lowest setting, a 266 nm wavelength, is used when processing the polycarbonate sheet 14. This setting produces less thermal damage than a higher wavelengths.

In the preferred embodiment, a Spectra-physics, flash lamp pumped, Q-Switched Nd:YAG laser is utilized, for example, in the laser cutting system 10. It has a maximum power of 39.4 W at the laser wavelength of 1064 nm and a repetition rate of 20 Hz. The laser may be operated at a power of 10.2 W when a wavelength of 355 nm is utilized. However, use of the laser at 355 nm wavelengths demonstrated a tendency to burn the edges of the polycarbonate sheet. Alternatively, and more preferably, the laser is operated at a power of up to 3.5 W when a 266 nm wavelength is utilized, as suggested above. In both cases, a duration time of 8 ns and a repetition rate of 20 Hz is utilized. The preferred optics system has a 128.9 mm focal length and a focused spot diameter of about 27.89 μm, in air and at room temperature. The laser system 10 further consists of the Nd:YAG laser head, power supply and analog controller 16. An alternate laser that could be employed, also provided by Spectra-physics, is a hippo-diode pumped laser operable at about 3-4 W at a 266 nm wavelength up to about 7 kHz. Such a laser has speed of processing advantages, but is not preferred commercially given typical cost constraints at this time.

In operation, laser beam “B” is delivered and manipulated by optical system 11. As illustrated in FIG. 3, the optical system 11 includes three prisms 32, 34, 36. Preferably, RAP-050-EJV and RAP-100-UV, CVI prisms are used to transport the laser beam “B” to a focusing lens 20. The prisms 32, 34, 36 are preferably made of fused silica and are designed for 90° bending of the laser beam. The two small prisms 32, 34 have a size of 0.5″ by 0.5″ and the other large prism 36 has a size of 1″ by 1″. The large prism 36 has a higher energy damage threshold to avoid damage from a reflection of a focused laser beam. The prisms 32, 34, 36 are generally aligned for the reflection of the laser beam away from the optical axis in order to avoid damage to the optical components.

Preferably, a circular aperture (iris) 38 is placed in the beam path to cut around the laser beam and control laser power. By changing the aperture 38 size, various sizes of beam spots can be generated without changing a position of focus lens 20. Preferably, a laser iris diaphragm (ID-1.0 series, Newport, for example) is used as the circular aperture 38. A spherical plano-convex lens (PLCX-25.4-64.4-UV, CVI, e.g.) is used as the focus lens 20 to focus the laser beam. The flat side of the preferred focus lens 20 prevents reflections of a focused beam from being directed back to the remaining optical components. The focus lens 20 is made of fused silica and allows for focus lengths of 128.9 mm, 135.3 mm, 139.8 mm and 143.2 mm for 266 nm, 355 nm, 532 nm and 1064 nm wavelengths respectively.

Preferably, the two small prisms 32, 34 are mounted with a rectangular prism mount (204-05R Right-Hand, CVI), onto an optics table in conventional fashion using posts, post holders, rod clamps and magnetic bases (not shown). The large prism 36 is located over the focus lens 20 and is mounted using a 3-axis prism mount (for example, a 1800 3-Axis Prism Mount, CVI). This mount allows the laser beam “B” to be easily aligned with the center of focus lens because of three eighty-pitch adjustment screws having a range of angle variation from −5° to +5°. The large prism 36 may also be positioned on the optics table using posts, post holders, rod clamps and the magnetic base. Preferably, the focus lens 20 is mounted to an x-y-z translation stage (for example, a 2493 x-y-z stage, CVI), allowing a maximum 28 mm movement, having an adjustment screw allowing for 34.95 μm movement per one pitch.

Preferably, the prisms 32, 34, 36 are aligned precisely in the beam path to deliver the laser beam B on the focus lens without losing energy or changing a shape of the laser beam. The height of the prisms 32, 34, 36 is set considering the thickness of the microstage 15 and the focus length of the focus lens 20. The aperture 38 is also positioned between two small prisms 32, 34 and is adjusted to a height at which the center of the aperture matches with that of the laser beam B. The delivered laser beam B is aligned to the center of the focus lens 20. If the laser beam B is not located on its center, the convex side of the focus lens can make the path of the laser beam tilt on the plate for the laser micro-machining. The distance between the focus lens 20 and the microstage 15 can be changed, and also the shape of the laser beam spot on the microstage 15 can be changed.

A microstage 15 is used to mount the polycarbonate 14. A vacuum chuck, for example, a CVC-6-20 from PhotoMachining Inc., is used to hold the polycarbonate 14 and to maintain its flat surface during laser machining. The ceramic top plate of the vacuum chuck has 20 μm has pores and is driven by a pump (DOA-P104-AA, GAST) that has a capacity of 30 in Hg vacuum. The size of the vacuum chuck is much larger than the polycarbonate 14, thus any unused part of the vacuum chuck can be covered by a thin sheet of plastic material to increase its holding force. Preferably, the vacuum chuck is fixed onto the microstage 15.

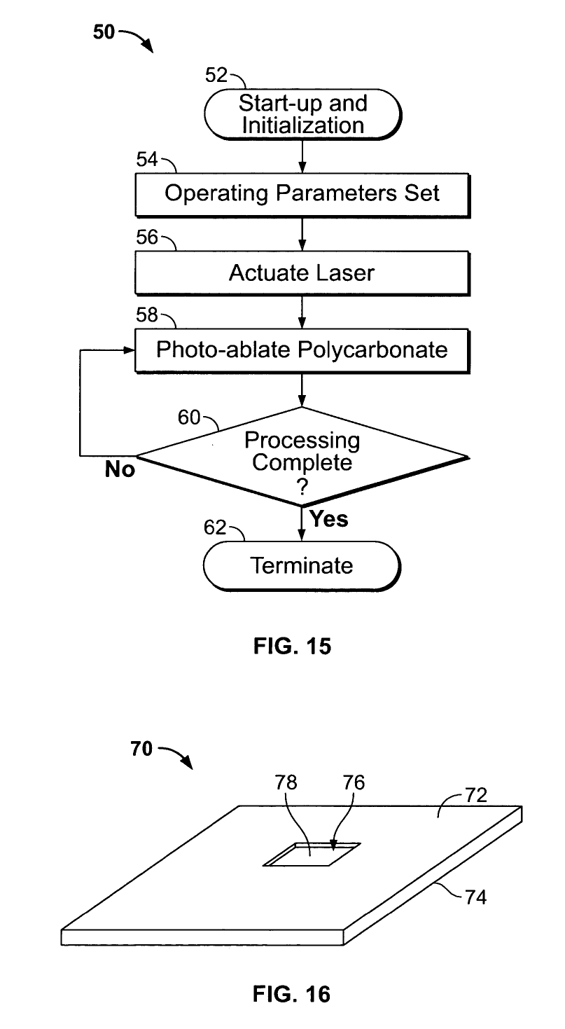

Whether or not a vacuum chuck is employed, a mounting jig 70 as shown in FIG. 15 is preferably used to hold polycarbonate substrate 14. More particularly, substrate 14 is mounted on jig 70 having top and bottom surfaces 72, 74, respectively, in such a manner that the substrate is mounted taut, with no backside interface, i.e., there is an air gap between the bottom of the substrate and the jig. Most preferably, the polycarbonate substrate 14 is attached to jig 70 with two-sided tape provided intermediate the substrate and top surface 72 of jig 70.

Jig 70 is preferably about a quarter inch thick, is made of plexi-glass and may be about an 8 in. by 8 in. square defining top and bottom surfaces 72, 74. At about a center 76, an opening 78 is milled out (about ⅛^{th} of an inch) to create the air gap behind the area of the substrate 14 that is to be processed. Preferably, opening 78 has dimensions of about 0.75 in. by 1.25 in. This free space or “air cushion” helps prevent unwanted and often problemsome markings on the reverse side of the thin polycarbonate sheets. More particularly, the air gap allows marking to be accomplished without marking the backside of substrate 14. This is due primarily to the fact that thermal energy can be dispersed, i.e., there is less heating at the substrate/jig interface. In addition, the likelihood that debris may be trapped at the substrate/jig interface during processing is greatly reduced given the reservoir created by the air gap.

A computer controlled x-y translation microstage, such as the LW-7 XY from Anorad Inc. may be utilized. The Anorad stage has a maximum 127 mm by 127 mm movement, with a 30 nm resolution and a speed from 0.1 μm/s up to 200 mm/s. The microstage 15 is controlled by a PC-based linear servo motor.

Preferably, the microstage 15 is connected to a 5U amplifier chassis consisting of a servo amplifier and several coprocessor boards. The main power board of the servo amplifier is an interface providing commands to two axes of servo amplifiers and communications with a PC-bus servo controller card. Jumpers are located on a backplane to direct encoder signals, to determine limit recognition and to enable control and safety signals for reliable, fail-safe operation. Protection circuits for various faults, including over temperature, over/under voltage, current overload and over speed, protect the amplifier and the motion control system from damages. Preferably, signals such as travel limits, brake fault and current limits are also provided. Front panel LED's provide indication of operating and fault conditions at a glance.

Several coprocessors may be used as the interface between the microstage 15 and the user. Preferably, a command from the user is interpreted through a command decoder and requested motion is broken up into smaller segments for each axis by a servo coprocessor. It provides the axis involved in the movement with path information generated via a high-speed data bus. Each axis card, having its own microprocessor, accepts and implements servo control commands at rapid rates.

Preferably, a CNC-2000 program is used to accomplish precision positioning and continuous motion for the laser micro-manufacturing of polycarbonate substrate 14. This software can handle motion commands, G and M functions and subroutines, which are combined into one program consisting of NC codes. Moreover, the CNC-2000 program allows users to edit the shapes of the micro structures for micro-manufacturing so they can be generated visually with a CAD program.

In order to initiate the laser system 10, the iris 38 is set to a diameter of about 3.5 mm. Focus lens 20 focuses the collimated beam B to a focus spot having a cross-sectional diameter, dₒ. Preferably, the focus spot size, dₒ, is approximately 10 to 100 microns. More particularly, the focus spot size, dₒ, is proportional to the frequency divided by the cross-sectional diameter “D” of the collimated laser beam reflected by a reflector. Or, more particularly, with reference to the following equation,
dₒ=4λM²/(πDᵢₙ) Equation 1
where λ is the wavelength, M² is the laser “times diffraction limit” (i.e., conventionally known as a measure of the quality of the laser), and Dᵢₙ is the width of the incoming multi-mode beam to the lens 20.

Typically, a user will want the smallest, i.e., most focused, spot size that still delivers good beam quality. A smaller spot size results in less beam interaction with the substrate 14, and typically yields a higher quality cut given that the recast effect (e.g., propulsion of particles into the processing environment is kept to a minimum and, in any event, is at such a level that the particles are consumed by the plume of the laser). Moreover, less electrical energy is typically required for processing than when using a large spot size, there is less waste of product and the depth of beam penetration is most often not compromised. Notably, however, with a larger iris, and thus a smaller beam spot, beam quality may be compromised due to the fact that the highest energy, most uniform portion of the beam is not passed by the iris. This is due to the fact that the laser typically will not produce a purely Gaussian (Normal) beam distribution. In that regard, a beam homogenizer 18 (FIG. 1) may be employed to improve the quality of the beam, and in the end, processing efficiency. Otherwise, a slightly larger spot size than otherwise preferred may have to be used.

Overall, however, the focus spot size is application dependent, and in some applications, the user might require a wider beam to scan the surface. For instance, when processing certain polycarbonate substrates, if the cut line is too narrow, the opposing edges of the substrate along the cut line may, in fact, still have a tendency to couple due to molecular level forces present at the interface

If a larger beam is desired for processing, the beam spot size may be increased by making the iris smaller. In particular, Dᵢₙ can be decreased by decreasing the size of the iris, which in turn increases dₒ (see Equation 1). This yields a high quality beam and causes the beam to ablate more area of the substrate at impact given the larger spot size. However, more power in watts, and ultimately, in electrical energy, is required to maintain the preferred fluence, J/mm², which is undesirable or even prohibitive for many applications.

Overall, a balance needs to be struck between generating a small spot size and achieving a requisite level of beam quality. Notably, the laser used does not typically produce a purely Gaussian (Normal) beam distribution. Therefore, reducing the size of the iris can improve beam quality, however, possibly at the expense of spot size. Again, based on the application, system parameters can be adjusted accordingly.

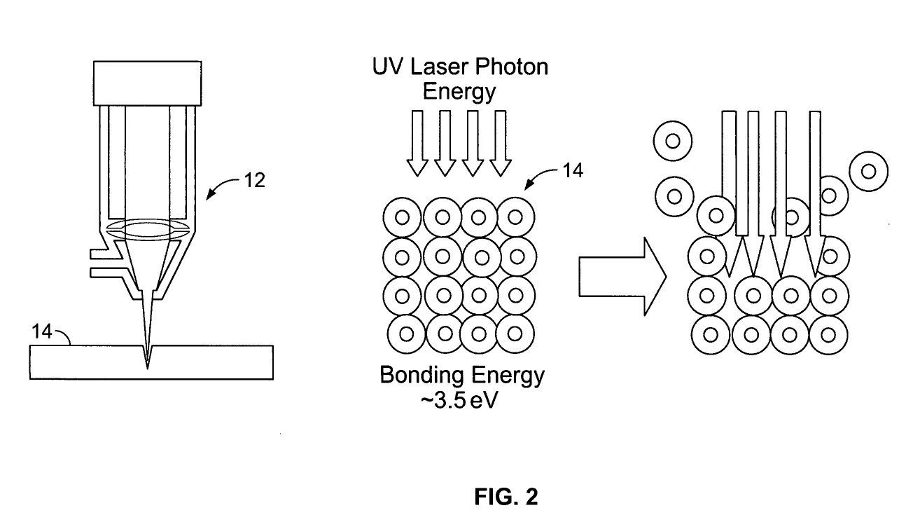

Turning to FIG. 2, polycarbonate processed by the UV laser system 10 is illustrated. In FIG. 2, polycarbonate 14, is shown in cross-section whereby UV laser photon energy generated by laser system 10 according to user-defined specifications is directed toward the polycarbonate 14 to process (i.e., cut or mark) the polycarbonate substrate 14.

The processing is accomplished via photo-ablation, whereby the binding energy of the molecules of the product to be processed is overcome, causing particles of the polycarbonate 14 to be broken apart without leaving a heat affected zone (HAZ) on the polycarbonate 14 to be cut or marked when specific parameters are utilized. More particularly, the molecules of the polycarbonate 14 absorb the photon energy in the UV range to cause photo-ablation. As a result, thermal effects, such as HAZs for instance, are minimized, thus achieving a primary goal of the preferred embodiments which is to minimize burning the polycarbonate.

In the case of polycarbonate substrate 14, the binding energy is approximately 3.5 eV. As the UV photons continue to impinge upon the polycarbonate 14 at ultraviolet photon energy of about 3.1 eV to 6.5 eV, the binding energy between the atoms of the polycarbonate 14 is broken, thus causing a cutting of the polycarbonate 14, as illustrated in FIG. 2. Importantly, again, the polycarbonate does not melt; rather, photo-ablation causes atoms to be “blasted” from the product, relatively in tact. As a result, a relatively clean cut is achieved, typically with a minimum waste of product.

The photon energy is proportional to Planck's constant (h=6.626×10⁻³⁴ J●s) times the frequency, such that the lower the wavelength (inversely proportional to the frequency) of the radiation, the greater the photon energy. The preferred wavelength of the UV energy, which is generally less than 400 nanometers, is between 150 and 280 nm and most ideally, approximately 266 nanometers, as suggested previously.

### EXAMPLES-PARAMETERS

Several experiments were performed to determine the preferred parameters of the laser ablation process. Initially, the iris 38 was set to a theoretical desired diameter. An effective diameter of 5 mm can be used, but a 3.5 mm diameter was preferred. A 3.5 mm iris was found to produce a high quality beam that allows the focus position along the Z axis to be more easily found and adjusted than other diameters. Furthermore, by decreasing the iris diameter the most uniform and strongest portion of the beam can be captured and directly used in the processing operation. The 3.5 mm diameter iris assisted in developing a high quality beam. Most generally, and as understood in the art, a smaller iris can operate to block the less uniform outer edges of the normally distributed beam, leaving the center, higher energy portion of the beam to impinge upon the substrate.

In order to initiate the laser system 10, the laser 12 is activated, and the beam is conditioned by adjusting the alignment knobs. Typically, the laser is run for several minutes, and the beam is checked for quality by looking at its image on white cardboard. Beam quality is generally used to describe focus position, and other parameters such as the duration the beam remains at the same power (in mili-watts), remains stable, and stays in focus. Typically, zap-it paper is used to make sure the beam is uniform, and circular, making sure that the beam falls uniformly in the center of each of the prisms (FIG. 3), and exits with a round shape before being focused. The beam position and quality is adjusted, generally, first by turning a lower adjustment knob to move the horizontal shutter of an adjustment block 33 of laser 12 in the vertical direction. Then the upper adjustment knob can be utilized to adjust the vertical shutter of adjustment block 33 in the horizontal direction. Overall, adjustment of the horizontal and vertical shutters of block 33 adjusts the laser beam's projection through the iris diameter, as shown in FIG. 3. In addition, the size (e.g., diameter) of the iris can be adjusted with an adjustment mechanism 39.

Once a good quality laser beam is found to be delivered from the laser, this initial beam is optimized. Preferably, optimization includes making sure that the beam is uniform along its path, that the above-mentioned shutters are aligned so that a round beam is delivered from the laser, and that the power of the beam is properly set for the desired application. Notably, a round beam typically will dissipate energy at the substrate uniformly, and provides an indication that the laser is working properly, and that the iris and prisms are aligned properly. Also, a round beam minimizes the possibility that something will go awry mid-process by providing more consistent and predictable processing.

The power of the beam is optimized using a power meter. A power meter target is placed in the path of the beam, after the beam exits the iris 38, but before it travels through the optics system 11. The meter captures the beam, delivering a readout of the beam's power in milliwatts. The laser alignment knobs are slowly adjusted to keep the beam stable during this time, and power on the laser is adjusted so that a beam of between 30 and 50 milliwatts is achieved

Notably, a beam of about 30-50 milliwatts produced a nice “readable” pattern on clear polycarbonate substrates. By altering the position of the z axis, one can determine the actual separation between the optics system and the focus spot, which may vary slightly from the theoretical separation based on the focal length. Laser stability is key in that it means that the beam consistently is delivered over the course of several minutes with uniform power, shape, and appearance (brightness). Ideally, the impinging beam is circular at the center, has a “bulls-eye” appearance, and is uniform. Once the power of the beam appears constant, the beam is monitored for about a couple of minutes to make sure that the beam maintains a constant power, as understood in the art. Once the beam is stable and the power is constant, the beam is focused for the desired application using laser manufacturer parameters.

Such parameters include analyzing beam focus and the beam quality, referred to as M². M² is the ratio of the laser beam's multimode diameter-divergence product to the ideal diffraction limited (TEM₀₀) beam diameter-divergence product. It can also be represented by the square of the ratio of the multimode beam diameter to the diffraction-limited beam diameter or,
M²˜(Dₘ*θₘ/d₀*θ₀)˜(Dₘ/d₀)² Equation 2

In the equation above, Dₘ is the measured beam waist diameter, θₘ is the measured full-angle divergence, d₀ is the theoretical “imbedded Gaussian” beam diameter, and θ₀ is the theoretical diffraction-limited divergence. The diameter-divergence products are given in units of mm●mrad. In addition to the quantities above, a quantity known as the Rayleigh range, denoted by Z_{R}, is used to find the focus position. The Rayleigh range is the distance a beam must propagate for its diameter to grow by a factor of \sqrt{2}. This point, as understood in the art, is the distance from the beam waist at which the radius of the beam is at a minimum. The \sqrt{2} factor is a scientific standard for determining how large the beam can be before one is no longer in focus, or nearly in focus. It defines the beam waist. Preferably, laser ablation processing is always done within the beam waist. The distance between the beam waist and the Rayleigh range is called the near field.

Overall, one wants the value M² to be as close to one as possible. The equations are used to theoretically analyze the quality of the beam. In practice however, the beam quality is determined by the brightness and consistency of the beam, as well as the characteristics of the imprint of the beam on zap-it paper or on the polycarbonate 14. In practice, pictures or other illustrations of various beam impact markings exist that correspond to different M values, and the practitioner can compare his or her beam quality to these pictures, as understood in the field. The picture guides are based on the equations.

Next, a preferred focus is where the beam has the narrowest diameter, and the beam is projected down in a parabolic shape. The following equation was utilized to develop the theoretical size of the focus area or diameter. We know from Equation 1 that the focus diameter is inversely proportional to the diameter at the input of the prism before it is focused. So a larger exiting beam produces a narrower diameter at the focus. It is a parabolic beam shape, like a funnel, and the larger the top of the funnel, the narrower the beam is at the bottom. A narrower beam has less cross-sectional area in contact with the substrate, and the recast effect (ablated material hitting the substrate) is less with a smaller diameter. Since less beam is interacting with the substrate compared to a larger beam spot, less power is required to deliver the same fluence J/mm². It is preferred to have the narrowest, most concentrated, powerful portion of the beam interact with the substrate to achieve optimum processing efficiency.
(C*λ*fl_{c})/Dᵢₙ˜(2.44*266*10⁻⁶ mm*128.9 mm)/3.5 mm˜f₁ Equation 3
In the equation above, C is a constant of 2.44, λ is the wavelength, fl_{c} is the focus lens constant (for the preferred lens fl_{c} was 128.9 mm) and D₀ is the original beam diameter delivered to the focal lens.

After a theoretical focus length is determined, processing due to the substrate being placed on and off a position corresponding to the actual focus length is analyzed. An NC code, or other known laser programming tool, is programmed to, in this case, cut lines 10 mm long at a speed of 10 mm/s thereby pulsing about 20 shots onto the substrate. The table is first positioned above the point of the theoretical focus length, and after each line is cut the height of the table is decreased. The actual diameter of the focus spot is found by analyzing these “shots”. The term shots refers to the circular cut region on the substrate resulting from a single pulse of the laser. The shots were examined to determine the depth and diameter of the shot. With respect to beam contact on the substrate further away from the theoretical focus length of the optics system, the shot pattern exhibits a fragmented center. Nearer the theoretical focus length, the shot pattern is continuous but lopsided, i.e., a circle with a protrusion. Once the beam contacts the substrate in the waist area, the beam is continuous and not lopsided. The diameter of these circles is measured with conventional imaging software. Again, as the beam grows larger, such that the diameter is more than \sqrt{2}* the diameter at the focus, one is no longer in the beam waist region. The ideal focus position is generally critical for cutting efficiently.

In the preferred embodiment, focusing on the bottom of the thin polycarbonate substrate actually produces the deepest, and therefore most efficient cut or mark. Typically, one does not process efficiently at positions other than at the focal length of the optics system. Notably, this can be useful when performing etching, scoring, or marking operations.

Once the focus spot is found according to desired processing parameters, samples were mounted, lines were cut onto the samples with the laser beam and several variables were examined. Speed was frequently altered in the experiments, and the term overlap is hereinafter used to describe the outcome when operating the laser at different speeds. More specifically, the term overlap refers to the amount of overlap between sequential circular cuts along a cutting path. As noted above, the laser ablation process utilizes a pulsed laser which generates and directs a series of individual pulses or shots towards the substrate during the cutting process resulting in a series of multiple circular cuts.

The amount of overlap between the individual cuts is directly proportional to the speed of the laser along the scanning (cutting) direction and the diameter of the individual cut. For example, as illustrated in FIG. 4, since the preferred laser operates at 20 Hz, when the laser is moved along the cutting path at a speed of 10 mm/s the cuts of the individual pulses have no overlap and are about 0.5 mm/s apart. When the laser is moved along the cutting path at a speed of 0.24 mm/s, the individual cuts overlap by about 50%.

More specifically, in order to determine the cutting speed required for 50% overlap, the focus spot diameter is first calculated. Then the following equation is utilized to calculate the cutting speed required to achieve a preferred overlap:
Cutting Speed˜D_{f}mm*20 hz*(1−overlap %) Equation 4
In the equation above, hd f is the diameter of the beam at its focus position, and 20 hz is the repetition rate for the preferred laser. Thus, the theoretical diameter of the focus is multiplied by 20 hz and the quantity “1-desired % overlap” to determine the speed in mm/second required to achieve the desired overlap. How much overlap is desired for a particular application is discussed in further detail below.
A. Depth vs. Fluence

In optimizing the cutting operation for particular applications, the fundamental interaction between varying two major parameters, the fluence of the laser beam and the speed (overlap) of the beam moving along the cutting path must be considered. Fluence is generally a measure of the quantity of light (or other radiation) falling on a surface of the substrate expressed in terms of energy per unit area. Laser power is increased to increase fluence. In addition, as suggested previously, a larger iris size, which results in a smaller focus beam size, can also be used to increase fluence at a given power. However, changing the iris size also changes the focal position, and thus must be considered especially if changed mid-application. In the example described hereinafter, regular uncoated polycarbonate was used, and a 5 mm diameter iris was selected.

For each of six samples, five lines were cut 3 mm apart on samples of the polycarbonate. For a given sample, the fluence was held constant and the speed was varied for each of the five lines to provide a different amount of overlap. The focus was positioned at a top surface of the substrate.

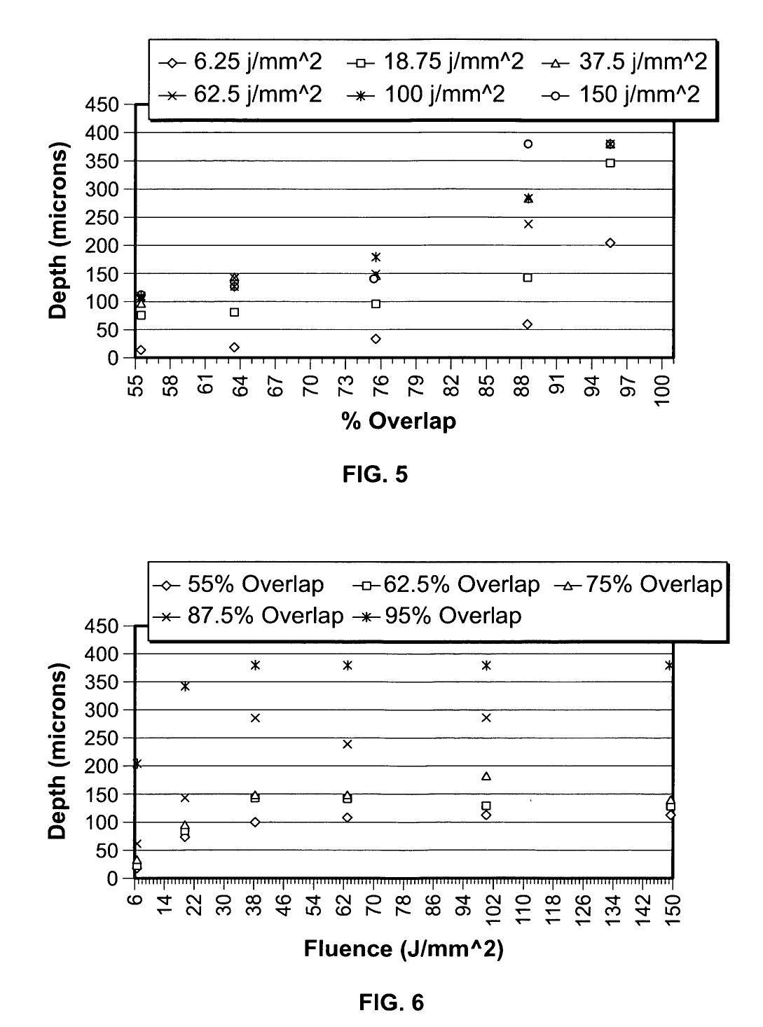

FIG. 5 is a performance graph illustrating the changes in depth as the amount of overlap (again, based on speed) was changed. The samples were about 381 μm thick. As the speed was slowed down and the resulting overlap was increased, the cutting depth gradually increased. For overlap between 55% to 90%, a moderate increase in depth is achieved. As the speed is slowed to 95% overlap, a dramatic increase in depth of cut is achieved. Unfortunately, for most applications, the increase in overlap also corresponded to higher cutting widths and HAZs—or heat affected zones. Notably, such zones are characterized by black carbon effects and a discoloring of the substrate.

FIG. 6 is a performance graph illustrating depth as a function of varying both the fluence and the speed. The experiments were run on a polycarbonate sample that was about 381 microns thick. As the fluence was increased, the depth of the cut increased. And, consistent with the above results, as the overlap was increased, the cutting depth also increased. As illustrated by FIG. 6, at 95% overlap even low fluences such as 18.75 J/mm² are able to cut completely through the polycarbonate.

Overall, parameters are selected to preferably maximize cutting efficiency from an electrical energy standpoint. For example, more energy can be used to produce a beam with a higher fluence (J/mm²); however, there is a point of diminishing returns beyond which increasing fluence minimally increases the depth of cut achieved.

As industry works to develop a system capable of higher cutting speeds, the parameters established pave the way for intelligently pursuing higher speeds. They show that given that there is a point of diminishing returns as one increases fluence, one preferably does not want to develop a lasing system that attempts to deliver more energy per pulse, but rather to develop a laser that generates a higher number of pulses per second, i.e., increase the laser frequency.

B. Depth vs. Fluence When Overlap is Varied Over Ink Coated and Uncoated Polycarbonate

The effects of coating the polycarbonate with different ink coatings was analyzed and optimized. Polycarbonate sheets of about 381 microns were used. Both black and white inks were used as well as inks that included what is known in the art as a craze coating. The iris was set preliminarily to a diameter of 3.5 mm, and the significance of the effect of different ink coatings was analyzed as parameters such as fluence and overlap were varied. Exemplary samples were 381 microns.

Fluence settings corresponding to 3, 6, 12, 20, 30, and 45 J/mm² were initially studied on regular polycarbonate. Thin samples were prepared, and placed on the jig as previously described. Lines were cut as the speed was altered between 25%, 50%, and 75% overlap at the varying fluences. Cross section mountings were prepared and the depth of cut was analyzed under a microscope. Identical experiments were run on polycarbonates coated with ink.

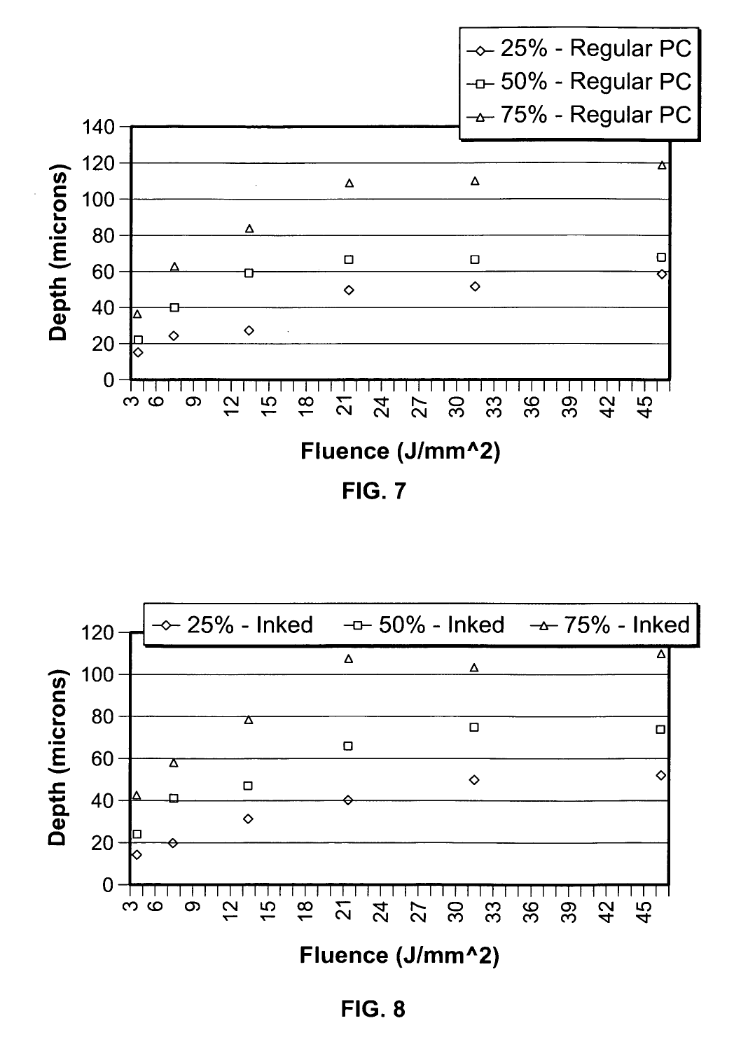

FIG. 7 is a performance graph illustrating the results of the experiment measuring depth as a function of fluence at different speeds for regular polycarbonate. FIG. 8 is a performance graph illustrating depth as a function of fluence at different speeds for inked polycarbonates.

As illustrated by FIGS. 7 and 8, very little difference in the depth of the cut was observed between inked and regular polycarbonate. However, in general, the inked cuts had more debris and were 5-10 microns wider. In addition, regardless of the coating, a similar depth of cut is achieved. That said, craze coatings improved the quality of the cut, as inked samples without craze were wider and less symmetrical in appearance. The craze coating serves as a protective layer minimizing the recast effect of the ablation process. Thus, the effect of a craze film over the surface of the sample was determined to minimize the widening effect.

C. Depth vs. Fluence on Coated Polycarbonate Samples

Next, the effect on the depth of cut when the fluence is varied on polycarbonate samples coated differently, with the speed being held constant, was analyzed and optimized. The samples were about 381 microns thick.

Using a 3.5 mm iris, five lines were cut on six different samples with varying coatings. Samples with coatings on top of the polycarbonate substrate were used for this analysis. Craze and ink layers had each previously been measured to add approximately eight microns to the overall thickness of the samples, and accordingly eight microns was used as the z height adjustment factor in determining the focus position. The following samples were analyzed:

craze coating only

craze coating over a black ink layer

craze coating over a white ink layer, both over a black ink layer

white ink layer covering a black ink layer

white ink layer only

black ink layer only

The lines were cut at a speed of 0.239032 mm/s thereby allowing 50% overlap at 20 hz. Fluences of 6, 12, 20, 30, and 45 j/mm² were analyzed. With the 3.5 mm iris, these fluences corresponded to powers of 54, 108, 179, 270 and 404 milliwatts, respectively.

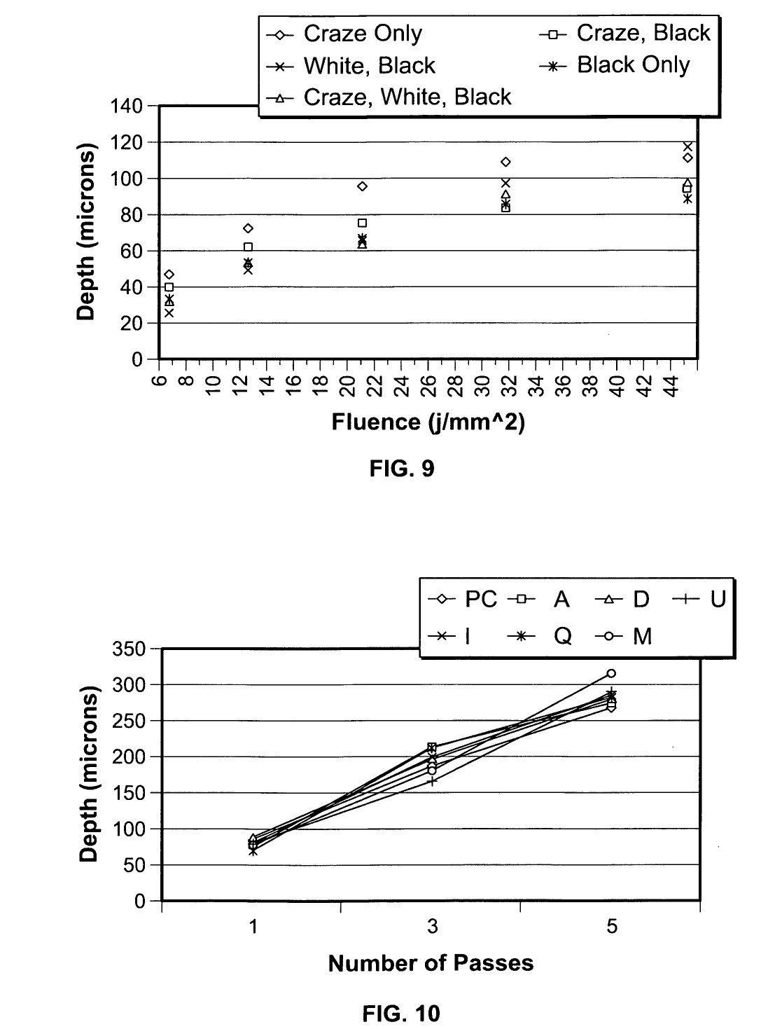

FIG. 9 is a performance graph illustrating depth as a function of fluence on the differently coated samples when speed is held constant at about 50% overlap. As illustrated by FIG. 9, and noted in previous experiments, an increase in fluence generally led to an increase in cutting depth. To produce the deepest and cleanest cut overall, coating the polycarbonate substrate with a craze material is preferred. Ink coated material exhibited cuts wider than regular polycarbonate or craze coated polycarbonate and thus for such applications it is preferred to use less overlap, i.e., increase the speed (of course, at a loss in cutting depth). Yes, craze coated or uncoated polycarbonate cut the cleanest. Because it is a tough textured coating, the craze can operate to reduce the negative recast effect, again, the partially ablated material that collides back with the substrate. More debris was left in the bottom and on the sides of the ink coated and craze and ink coated polycarbonate than was left with the regular and craze coated polycarbonate.

Notably, to more specifically minimize the recast effect, especially with ink-coated samples, one can dispose a thin polyethelene film on the polycarbonate substrate 14. Though such a coating requires slightly more energy to penetrate, falling debris from the recast effect landed on the film and minimized the degradation of the cut.

D. Effect of Multiple Passes and Adjustment of the Focus Position

Thus, in order to penetrate the polycarbonate material completely in one pass, one would need to travel at a very slow speed. Therefore, it is preferred in a commercial setting to use multiple passes. An understanding of how multiple passes affect the cut was determined by analyzing and optimizing cutting 0.020″ (508 micron) thick polycarbonate. The iris diameter was 3.5 mm.

The effects of lowering the optics system/substrate separation, for example, by raising the substrate platform or jig, i.e., changing the focus spot position, is provided below. Initially, the spot position can be adjusted in an attempt to reduce the recast effect of the laser ablation process. Again, the recast effect generally refers to the ablated material that is propelled away at high speeds during the laser ablation process. This ablated material can impact and cause blemishes on the surface of the substrate leading to a poor quality cut. After each pass, the Z height of the stage holding the substrate was reduced fifty microns, thereby moving the focus spot position. The opposite effect was studied by increasing the Z height of the stage fifty microns after each pass, thereby moving the focus spot position into the substrate, or in other words, changing the focus spot position so that after each pass, the optics would be focusing into the already ablated region.

FIG. 10 is a performance graph illustrating the depth of a cut when the number of passes is changed, but the Z height is set so the beam remains focused at the top of the substrate. The curves correspond to processing substrates having the following characteristics:
pc—uncoated/uninked polycarbonate (pc);
A—top—craze coating, middle regular pc, bottom surface not coated;
D—top craze coating on top of a black coating, middle regular pc, bottom surface not coated;
I—top, craze coating on top of white, on top of black, middle is reg. pc, bottom surface not coated;
Q—top, white coating, on top of black coating, middle is reg. pc, bottom surface not coated;
M—top white coating only, middle is reg. pc, bottom surface not coated; and
U—top black coating only, middle is reg. pc, bottom surface not coated.

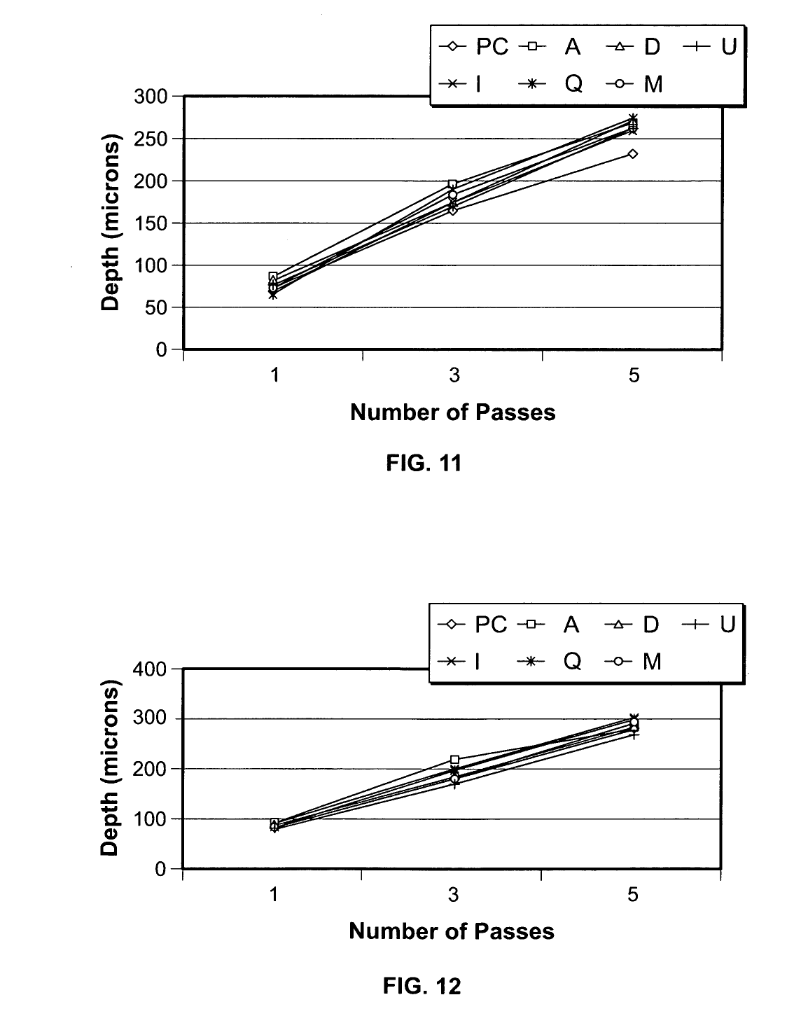

FIG. 11 is a performance graph illustrating depth of a cut versus the number of passes when the speed is held constant at 50% overlap and the preferred fluence at 20 J/mm². After each pass, the z value of the table/stage is dropped by fifty microns. FIG. 12 is a performance graph illustrating depth versus the number of passes when the speed is held constant at 50% overlap, and fluence at 20 J/mm², wherein after each pass the z value of the table is increased by fifty microns thereby decreasing the focal length.

As FIGS. 10-12 indicate, increasing the number of passes generally led to an increase in cutting depth. Decreasing the separation so the focus spot lies beneath the sample surface after subsequent passes generally increased the depth of cut, whereas increasing the separation produced slightly shallower cuts. Increasing and decreasing the optics/polycarbonate separation did not produce better or worse quality cuts than when the beam was focused at the substrate surface. Thus it appears that adjusting the focus separation after each cut has no effect on the recast effect.

E. Position of the Focus Spot

The optimum focus position was then determined. Regular 0.015″ polycarbonate was typically used for finding the focus. First, the focus position was found at the top of the sample, as with the traditional method. Then, using the thickness of the sample as a basis for calculation, the focus position was altered by increasing the z value of the table holding the substrate so that the focus spot position was lowered in FIG. 1. The focus position was then set to the middle of one sample, and to the bottom of another sample.

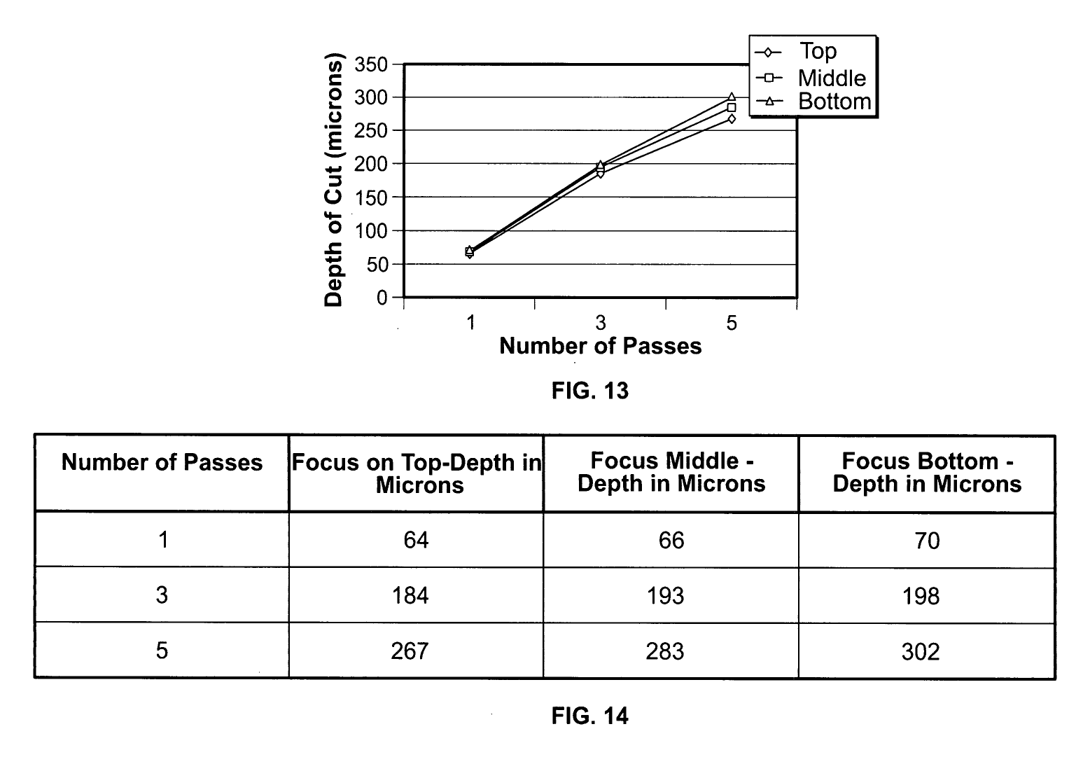

FIG. 13 is a performance graph illustrating the results of the depth versus number of passes when the focus position is aimed at the top, middle, and bottom of a sample of polycarbonate. FIG. 14 is a performance table illustrating the actual data for focus position and the number of passes. As illustrated by the results shown in FIGS. 13 and 14, focusing on the bottom of the sample will have the most efficient cut as in all cases the deeper the focus spot position, the deeper the cut.

In sum, a pulsed UV laser producing a beam with, for example, a 266 nm wavelength is demonstrated to effectively cut polycarbonate thin sheets. Cutting parameters have been established to achieve a predictable depth, while maintaining a quality cut with minimal thermal and debris defects.

A fluence level 20 J/mm² is preferred for efficient cutting with a 266 nm beam, as further increases in fluence do not achieve great increases in depth and can lead to detrimental thermal effects. Cutting over multiple passes at a speed allowing for about 25% overlap between pulses is also preferred. However, cutting with no overlap between pulses, i.e., at about a speed twice that of the speed used for 25% overlap, produces an even more efficient cut for most polycarbonate samples, as less time is required to make the cut in each pass.

Efficient cutting is further achieved by focusing on the bottom of the polycarbonate substrate. For example, focusing 400 microns beneath the top of the substrate is generally ideal. Raising the z-table 20 microns after each pass when operating at 20 J/mm² increases the cutting efficiency by approximately 10%. Multiple passes produce a cleaner cut than slower speeds employing fewer passes. Moreover, the depth of cut increases in a substantially linear manner as the number of passes is increased. A 3.5 mm iris in the optical set up produces a high quality beam, and this setting is preferred because the focus position (in “Z”) can be readily found.

Control of the recast effect of this process was also studied. Utilizing a film (e.g., a thin (50 micron) removable polyethylene film, or a permanent coating adhesive glaze known in the art as a craze coating) over the top layer of the substrate was shown to minimize the recast. When multiple passes were made, the film had a negligible influence on total depth, especially when focusing on the bottom of the substrate.

Method of Cutting Polycarbonate

Turning to FIG. 15, a method 50 of cutting a polycarbonate using a pulsed UV laser is illustrated. After a start-up and initialization Block 52, the UV laser operating parameters are set in Block 54, according to the above-described relationships optimized for the desired application. The control system then actuates the laser to direct the photo-ablation beam towards the polycarbonate in Block 56. Once the binding energy is overcome, photo-ablation occurs, typically for a predetermined time period, and the desired cut is made in Block 58 prior to further processing. In Block 60, the method determines if the cutting operation is complete. If not, the photo-ablation process is continued in Block 58 (for example, using multiple passes) until processing of the polycarbonate is complete. Notably, the cut is preferably optionally monitored in situ so that a control algorithm can be implemented to effectuate a sufficient number of passes for the desired cut. By conducting experiments, charts can be produced so that the user knows how many passes it will take at a given speed to perform the processing operation (e.g., penetrate through when cutting, or in the case of scribing, about how deep a certain number of passes will cut). Once processing is complete, the method terminates in Block 62.

In sum, scribing, etching, or otherwise marking the polycarbonate thin sheets can be performed to controlled depths with repeatability. It is therefore possible to not only cut polycarbonate thin sheets, but also to scribe, mark, etch, and perforate to known depths. Moreover, the opaque coating over a clear polycarbonate base can be ablated through, allowing light to shine through the desired areas. A colored coating on the non-ablated side changes the appearance of the markings, and may have a number of decorative applications. For example a faceplate, for a watch could be made allowing light to travel through the etched tick marks. The technique could be used for other applications, such as making masks for rapid prototyping applications. The coated polycarbonate mask would be etched, allowing light to pass through only where desired, and then the photo mask used to selectively photo-cure polymers.

Although the best mode contemplated by the inventors of carrying out the present invention is disclosed above, practice of the present invention is not limited thereto. For example, to further increase speed a diode-pumped solid-state (DPSS) solid state US laser with larger repetition rates (100 kHz to 300 kHz, for example) could be implemented to improve processing performance including speed. It will be manifest that various additions, modifications and rearrangements of the features of the present invention may be made without deviating from the spirit and scope of the underlying inventive concept.

What is claimed is:

1. A method of cutting a polycarbonate substrate, the method comprising the steps of:
providing an optical system including a source of pulsed ultraviolet (UV) radiation;
directing the UV radiation at the polycarbonate substrate; and
controlling the optical system so as to photo-ablate the polycarbonate substrate.

2. The method of claim 1, wherein said controlling step includes selecting a combination of parameters associated with the optical system.

3. The method of claim 2, wherein the parameters include at least one of a group including laser fluence, percent overlap, a number of passes of the radiation over at least a portion of a pattern to be machined in the polycarbonate substrate, a separation between the optical system and a top surface of the polycarbonate substrate, and a focal length of the optical system.

4. The method of claim 3, wherein said selecting step includes altering the percent overlap so as to increase cutting efficiency.

5. The method of claim 4, wherein the percent overlap is greater than about 25%.

6. The method of claim 2, further comprising adjusting at least one parameter of the combination to focus the beam substantially at the bottom of the polycarbonate substrate.

7. The method of claim 2, further comprising actuating a microstage substantially in Z to raise the polycarbonate substrate mounted thereon to change the separation.

8. The method of claim 7, wherein said actuating step is performed after each pass of a series of passes.

9. The method of claim 8, wherein the microstage is raised about 20 microns after each pass.

10. The method of claim 3, wherein the number of passes corresponds to a selected depth of a cut in the polycarbonate substrate.

11. The method of claim 10, wherein the depth corresponds to the entire thickness of the polycarbonate substrate.

12. The method of claim 1, wherein the UV radiation has a wavelength in a range equal to about 150 nm to 280 nm.

13. The method of claim 12, wherein the UV radiation has a wavelength equal to about 266 mn.

14. The method of claim 1, wherein the optical system includes an iris, the iris having a diameter of less than about 6 mm.

15. The method of claim 14, wherein the diameter is about 3.5 mm.

16. The method of claim 3, wherein the laser fluence is about 20 J/mm².

17. The method of claim 1, further comprising coating the polycarbonate substrate with a film layer.

18. The method of claim 17, wherein the film layer is comprised of a craze coating.

19. The method of claim 1, further comprising mounting the substrate on a jig coupled to a microstage, the jig including an opening over which at least a portion of the substrate is placed so that at least a portion of the substrate to be ablated is suspended in air.

20. The method of claim 1, wherein the substrate has a thickness less than about 2 mm.

21. The method of claim 20, wherein the substrate has a thickness less than about 1 mm.

22. The method of claim 21, wherein the substrate has a thickness less than about 0.2 mm.

23. An apparatus for cutting a polycarbonate substrate, the apparatus comprising:
an optical system emitting radiation having a wavelength in the ultraviolet range;
an optical system to condition the radiation; and
wherein a combination of parameters associated with the optical system is selected so that the radiation photo-ablates the polycarbonate substrate.

24. The apparatus of claim 23, wherein the parameters include at least one of a group including fluence, scanning speed, a number of passes of the radiation over a user-selected pattern to be machined, a focal length of the optical system, a separation between the optical system and a top surface of the substrate, and a focus spot size.

25. The apparatus of claim 23, wherein the UV radiation has a wavelength in a range of about 150 nm to 280 nm.

26. The apparatus of claim 25, wherein the UV radiation has a wavelength equal to about 266 nm.

27. The apparatus of claim 23, wherein the substrate is coated with a coating.

28. The apparatus of claim 27, wherein the coating is a craze coating.

29. The apparatus of claim 24, wherein the speed defines an overlap of consecutive pulses of the radiation.

30. The apparatus of claim 29, wherein the overlap is less than about 25%.

31. The apparatus of claim 30, wherein the overlap is about zero in one pass, and is non-zero over a series of passes.

32. The apparatus of claim 23, wherein the optical system includes a laser and an attenuator.

33. The apparatus of claim 32, wherein the attenuator is an iris having a diameter less than about 6 mm.

34. The apparatus of claim 33, wherein the diameter is equal to about 3.5 mm.

35. The apparatus of claim 24, wherein the substrate is coupled to a movable microstage.

36. The apparatus of claim 35, wherein said microstage is controllable to change the separation.

37. The apparatus of claim 36, wherein the separation is changed in situ.

38. The apparatus of claim 35, further comprising a jig, said jig supporting the substrate and being coupled to said microstage.

39. The apparatus of claim 38, wherein said jig includes an opening over which at least a portion of said substrate is placed so that at least a portion of the substrate to be ablated is suspended in air.

40. The apparatus of claim 39, wherein the substrate is coupled to said jig with two-sided tape.

41. The apparatus of claim 24, wherein the substrate has a thickness less than about 2 mm.

42. The apparatus of claim 41, wherein the substrate has a thickness less than about 1 mm.

43. The apparatus of claim 42, wherein the substrate has a thickness less than about 0.2 mm.

44. An apparatus for processing a polycarbonate sheet, the apparatus comprising:
an optical system emitting radiation having a wavelength of about 266 nm, wherein the radiation is directed towards a polycarbonate substrate so as to photo-ablate the polycarbonate substrate.

45. The apparatus of claim 44, wherein the processing operation is defined by a combination of parameters associated with said optical system.

46. The apparatus of claim 45, wherein the combination includes fluence, scanning speed, number of passes of the radiation, focal length, focus position and focus spot size.

47. The apparatus of claim 44, wherein the wavelength is about 266 nm, the fluence level is greater than about 15 J/mm² and the laser makes multiple passes at a speed allowing for about 25% overlap.

48. A method of cutting polycarbonate sheets, the method comprising the steps of:
providing a laser that generates ultraviolet (UV) radiation;
directing the UV radiation towards the polycarbonate sheet so as to photo-ablate the polycarbonate sheet; and
selecting a combination of parameters associated with said directing step including scanning speed, presence of a coating on the polycarbonate sheet, number of passes of the radiation over a selected pattern of processing the polycarbonate sheet, a focal length of an optical system associated with said directing step, a focus position and a focus spot size of the optical system.

49. The method of claim 48, wherein the sheet is less than about 2 mm thick.

50. The method of claim 49, wherein the sheet is less than about 1 mm thick.

51. The method of claim 50, wherein the sheet is less than about 0.2 mm thick.
